(19) United States
(12) Patent Application Publication
(10) Pub. No.: US 2002/0158735 A1
(43) Pub. Date: Oct. 31, 2002

(54) Magnetic apparatus for oil filters

(76) Inventor: Robert Rightmire, El Monte, CA (US)

Correspondence Address: Richard W. Goldstein, 2071 Clove Road, Staten Island, NY, 10304, US

(21) Appl. No.: 09/844,612

(22) Filed: Apr. 27, 2001

(51) Int. Cl. H01F 7/02

(52) U.S. Cl. 335/302

(57) ABSTRACT

A magnetic apparatus for oil filters including a magnet removably coupled with respect to the oil filter for preventing loose metal particulate from circulating within an engine.

### BACKGROUND OF THE INVENTION

The present invention relates to a magnetic apparatus for oil filters and more particularly pertains to preventing metal shavings from recirculating throughout an engine.

The use of oil filters is known in the prior art. More specifically, oil filters heretofore devised and utilized for the purpose of filtering oil are known to consist basically of familiar, expected and obvious structural configurations, notwithstanding the myriad of designs encompassed by the crowded prior art which have been developed for the fulfillment of countless objectives and requirements.

While these devices fulfill their respective, particular objective and requirements, these patents do not describe a magnetic apparatus for oil filters for preventing metal shavings from recirculating throughout an engine.

In this respect, the magnetic apparatus for oil filters according to the present invention substantially departs from the conventional concepts and designs of the prior art, and in doing so provides an apparatus primarily developed for the purpose of preventing metal shavings from recirculating throughout an engine.

Therefore, it can be appreciated that there exists a continuing need for a new and improved magnetic apparatus for oil filters which can be used for preventing metal shavings from recirculating throughout an engine. In this regard, the present invention substantially fulfills this need.

### SUMMARY OF THE INVENTION

In the view of the foregoing disadvantages inherent in the known types of oil filters now present in the prior art, the present invention provides an improved magnetic apparatus for oil filters. As such, the general purpose of the present invention, which will be described subsequently in greater detail, is to provide a new and improved magnetic apparatus for oil filters which has all the advantages of the prior art and none of the disadvantages.

To attain this, the present invention essentially comprises a circular band adapted for extending around the outer casing portion of the oil filter. The circular band includes a pair of semicircular segments each having opposed first and second free ends. The first free ends of the semicircular segments are adjustably coupled together by a tension spring whereby tightening of the spring will bring the second free ends together to snugly engage the outer casing portion of the oil filter. A pair of magnets is coupled with respect to the oil filter. The magnets are embedded within the semicircular segments of the circular band.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved magnetic apparatus for oil filters which has all the advantages of the prior art oil filters and none of the disadvantages.

It is another object of the present invention to provide a new and improved magnetic apparatus for oil filters which may be easily and efficiently manufactured and marketed.

It is a further object of the present invention to provide a new and improved magnetic apparatus for oil filters which is of durable and reliable construction.

An even further object of the present invention is to provide a new and improved magnetic apparatus for oil filters which is susceptible of a low cost of manufacture with regard to both materials and labor, and which accordingly is then susceptible of low prices of sale to the consuming public, thereby making such a magnetic apparatus for oil filters economically available to the buying public.

Even still another object of the present invention is to provide a new and improved magnetic apparatus for oil filters for preventing metal shavings from recirculating throughout an engine.

Lastly, it is an object of the present invention to provide a new and improved magnetic apparatus for oil filters including a magnet removably coupled with respect to the oil filter.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the magnetic apparatus for oil filters constructed in accordance with the principles of the present invention.

FIG. 2 is an exploded perspective view of the present invention.

FIG. 3 is an exploded perspective view of an alternate embodiment of the present invention.

The same reference numerals refer to the same parts through the various figures.

### DESCRIPTION OF THE PREFERRED EMBODIMENT

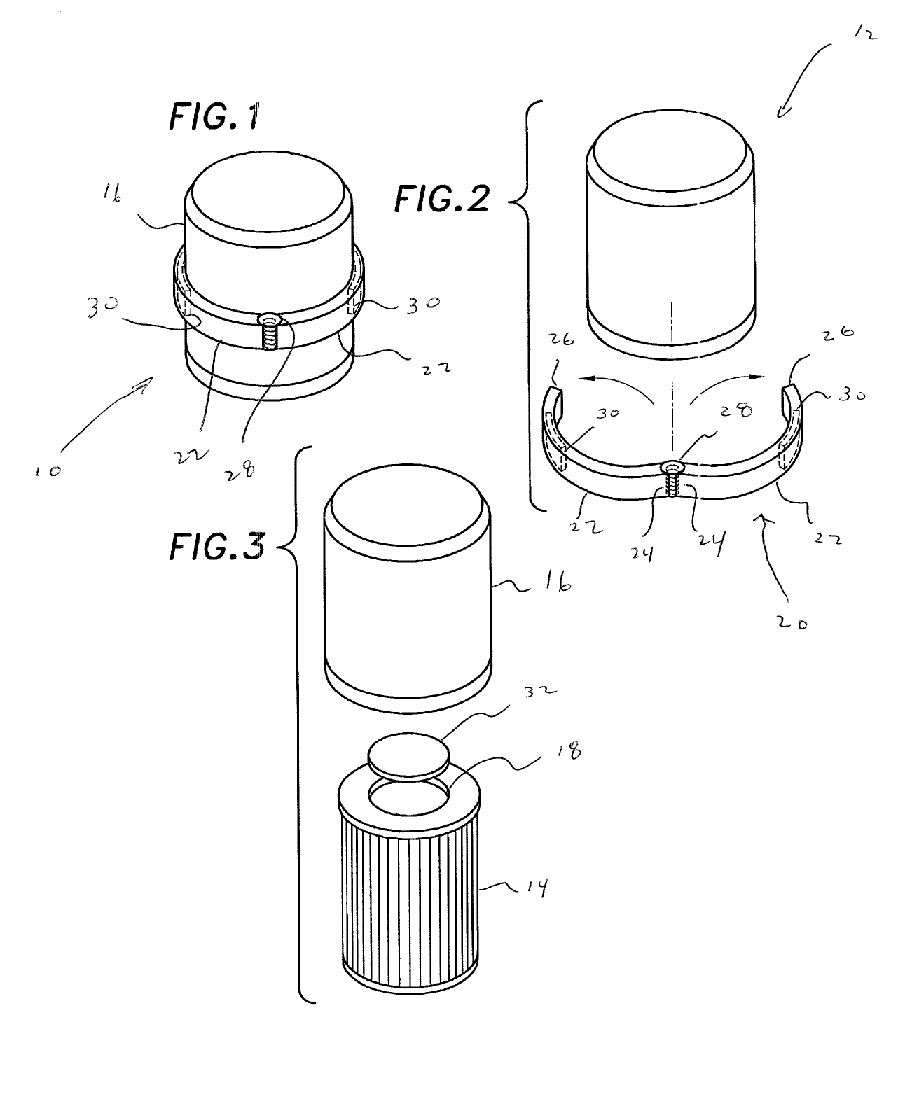

With reference now to the drawings, and in particular, to FIGS. 1 through three thereof, the preferred embodiment of the new and improved magnetic apparatus for oil filters embodying the principles and concepts of the present invention and generally designated by the reference number 10 will be described.

Specifically, it will be noted in the various Figures that the device relates to a magnetic apparatus for oil filters for preventing metal shavings from recirculating throughout an engine. In its broadest context, the device consists of a circular band and a pair of magnets. Such components are individually configured and correlated with respect to each other so as to attain the desired objective.

The present invention is designed for use on a standard oil filter 12. These oil filters typically include an interior filter portion 14 and an outer casing portion 16. Both of these components are not constructed with the use of any metals. The interior filter portion 14 contains a recess 18 on an upper end thereof.

The circular band 20 is adapted for extending around the outer casing portion 16 of the oil filter 12. Note figures one and two. The circular band 20 includes a pair of semicircular segments 22 each having opposed first and second free ends 24,26. The first free ends 24 of the semicircular segments 22 are adjustably coupled together by a tension spring 28 whereby tightening of the spring 28 will bring the second free ends 26 together to snugly engage the outer casing portion 16 of the oil filter 12.

The pair of magnets 30 are coupled with respect to the oil filter 12. The magnets 30 are embedded within the semicircular segments 22 of the circular band 20. In the preferred embodiment, the magnet's 30, when the circular band 20 is positioned around the oil filter 12, are diametrically opposed so as to attract metal particulate within the oil filter 12 to the greatest degree. It should also be noted that the positioning of the circular band 20 with respect to the oil filter 12 should be essentially intermediate the upper and lower ends of the outer casing portion 16.

A second embodiment of the present invention is shown in FIG. 3 whereby the circular band 20 is replaced by a single magnetic disk 32 that can be positioned within the recess 18 that is formed in the upper end of the interior filter portion 14 of the oil filter 12.

Both the preferred embodiment and the second embodiment allow for the reuse of the present invention once the oil filter 12 is removed and replaced during a standard oil change.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A magnetic apparatus for oil filters for preventing metal shavings from recirculating throughout an engine, whereby the oil filter comprises an interior filter portion and an outer casing portion, the interior filter portion containing a recess on an upper end thereof, the apparatus comprising, in combination:
a circular band adapted for extending around the outer casing portion of the oil filter, the circular band including a pair of semicircular segments each having opposed first and second free ends, the first free ends of the semicircular segments being adjustably coupled together by a tension spring whereby tightening of the spring will bring the second free ends together to snugly engage the outer casing portion of the oil filter; and
a pair of magnets coupled with respect to the oil filter, the magnets being embedded within the semicircular segments of the circular band.

2. A magnetic apparatus for oil filters for preventing metal shavings from recirculating throughout an engine, whereby the oil filter comprises an interior filter portion and an outer casing portion, the interior filter portion containing a recess on an upper end thereof, the apparatus comprising, in combination:
a magnet removably coupled with respect to the oil filter.

3. The magnetic apparatus for oil filters as set forth in claim two, wherein and further including a circular band adapted for extending around the outer casing portion of the oil filter, the magnet being embedded within the circular band.

4. The magnetic apparatus for oil filters as set forth in claim three, wherein the circular band includes a pair of semicircular segments each having opposed first and second free ends, the first free ends of the semicircular segments being adjustably coupled together by a tension spring whereby tightening of the spring will bring the second free ends together to snugly engage the outer casing portion of the oil filter.

5. The magnetic apparatus for oil filters as set forth in claim two, wherein the magnet is removably positionable within the recess on the upper end of the interior filter portion of the oil filter.
